(19) United States
(12) Patent Application Publication
(10) Pub. No.: US 2016/0086294 A1
(43) Pub. Date: Mar. 24, 2016

(54) REAL ESTATE SEARCHING AND MATCHING WEB PLATFORM

(71) Applicant: Johnny Constantin Khamis, San Jose, CA (US)

(72) Inventor: Johnny Constantin Khamis, San Jose, CA (US)

(21) Appl. No.: 14/491,997

(22) Filed: Sep. 20, 2014

(51) Int. Cl. G06Q 50/16

(52) U.S. Cl. CPC G06Q 50/16; G06Q 40/025

(57) ABSTRACT

A method comprises creating a tenant profile in at least one database based on a request of a prospective tenant, receiving, from the prospective tenant, real estate preferences associated with a desired real estate property, and associating the real estate preferences with the tenant profile. The method further comprises creating a property owner profile in the at least one database based on a request of a property owner, receiving from the property owner tenant preferences associated with a desired prospective tenant, and associating the tenant preferences with the property owner profile. The method further comprises matching, based on the real estate preferences and the tenant preferences, the property owner profile to the tenant profile, calculating a match score, determining that the match score is above a predetermined value, and, based on the determination, enabling interactions between the property owner and the prospective tenant.

### TECHNICAL FIELD

This disclosure relates generally to data processing and, more specifically, to a real estate searching and matching web platform.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Traditionally, rental properties are introduced into the marketplace by listings created by property owners or their real estate agents. Today, real estate listings are widely available and easily accessible by prospective tenants, buyers, or their agents on the Internet. For example, if a prospective tenant is relocating and wants to lease an apartment in a new city, the prospective tenant can visit a real estate website, run a search, find real estate offers, and get contact information for a property owner or agent associated with the real estate offers. The prospective tenant can then contact the property owner to negotiate the price and enter into a leasing contract.

However, a prospective tenant may also be interested in performing additional research with regards to the real estate property he has located. For example, the prospective tenant may be interested in learning more about the property owner by viewing comments and reviews posted by previous tenants. The prospective tenant may be also interested to learn more about the area associated with the property, such as demographics, public transportation, parks, recreational centers, schools, stores, and so forth. Thus, prospective tenants would have to conduct additional research which can be time consuming and bothersome.

Similarly, property owners would want to have more information on their prospective tenants. When a property owner leases a property to a tenant, he runs various risks including risks related to the tenant not paying rent, damaging the property, disturbing neighbors, or conducting criminal activities, all of which can be detrimental to the property and the owner. Consequently, to minimize these risks, property owners may want to screen tenants before they enter into a contractual relationship. Typically, property owners use third parties for screening potential tenants. The third parties can provide valuable information, which may include income verification and history, credit scores, criminal histories, eviction histories, and so forth. However, tenant screening creates additional burdens for the property owner, consuming time and delaying the process.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present technology is related to systems and methods for searching and matching real estate offers to requirements of prospective tenants. These systems and methods may be used overcome at least some drawbacks of existing solutions. More particularly, the present technology may allow for automatic matching of prospective tenant profiles to property owner profiles based on predetermined rules, as well as matching properties to preferences of prospective tenants. In addition, the present technology may allow for automated screening of tenants. Moreover, the present technology facilitates automatic aggregation of additional information associated with a particular property owner, real estate listing, or neighborhood, and makes this additional information available to prospective tenants before they enter into a lease contact.

According to one illustrative embodiment of the present disclosure, there is provided a method, which can be implemented by a processor as part of a larger computing device. One example of the computing device includes a server, and another example includes a distributed computing system involving multiple interconnected computing devices, such as servers, which is an approach known as “cloud computing.” The method can include creating a tenant profile in at least one database based on a request of a prospective tenant; receiving, from the prospective tenant, real estate preferences associated with a desired real estate property; and associating the real estate preferences with the tenant profile. The method can further include creating a property owner profile in the at least one database based on a request of a property owner, receiving from the property owner tenant preferences associated with a desired prospective tenant, and linking the tenant preferences to the property owner profile. The method can further comprise matching, based on the real estate preferences and the tenant preferences, the property owner profile to the tenant profile and calculating a match score, determining that the match score is above a predetermined value, and, based on the determination, enabling interactions between the property owner and the prospective tenant.

In certain embodiments, the enabling of interactions may include displaying the property owner profile to the prospective tenant or displaying the tenant profile to the property owner. In other embodiments, the enabling of interaction may include providing a user interface enabling the prospective tenant to send electronic messages to the property owner, or enabling the property owner to send electronic messages to the prospective tenant. In yet other embodiments, the enabling of interaction may comprise outputting the match score and at least some information related to the property owner profile and the tenant profile to a third-party server for further processing.

In certain embodiments, the method may further include conducting a criminal record check on the prospective tenant based at least in part on the tenant profile and updating the tenant profile with a result of the criminal record check. In other embodiments, the method may further comprise conducting a credit history check on the prospective tenant based at least in part on the tenant profile and updating the tenant profile with results of the credit history check. In yet another embodiment, the method may further comprise conducting an income verification of the prospective tenant based at least in part on the tenant profile and updating the tenant profile with results of the income verification. In yet another embodiment, the method may comprise conducting employment verification of the prospective tenant based at least in part on the tenant profile and updating the tenant profile with results of the employment verification.

In certain embodiments, the method may further comprise providing at least one user interface accessible by the prospective tenant and/or the property owner, wherein the at least one user interface enables the prospective tenant to create and modify the tenant profile, the property owner to create and modify the property owner profile, the prospective tenant and the property owner to communicate with each other, and the prospective tenant and the property owner to search third-party property owner profiles and/or third-party tenant profiles. In some embodiments, at least one user interface may further comprise a map, with the at least one user interface being further enabled to indicate on the map a location of at least one real property of the property owner based at least in part on the property owner profile. In some embodiments, the at least one user interface is further enabled to indicate on the map locations of one or more the following: a day care, a preschool, a school, and a college.

In yet further embodiments, the at least one user interface is further enabled to display locations of one or more the following on the map: a park, a recreational center, a public transportation stop, a store, a mall, an office, a hospital, a police department, and a fire department. Moreover, in some embodiments, the at least one user interface is further enabled to display on the map a rank associated with one or more of the following: a day care, a preschool, a school, and a college. In yet more embodiments, the at least one user interface is further enabled to display on the map a rank associated with one or more the following: an income level and crime statistics.

In certain embodiments, the method may further comprise aggregating ranking and statistical information associated with a plurality of locations, wherein the ranking and statistical information for each location comprises at least the following: a school rank, day care rank, college rank, crime related statistics, income statistics, and other demographics. The real estate preferences associated with the desired real estate property may comprise a location and at least the following: a type of the real estate property, a number of bedrooms, a square footage, a price, and a proximity to predetermined locations. The tenant preferences associated with a desired prospective tenant may comprise at least one of the following: a gender, an age, a number of prospective tenants, a price, an income level, a credit score, and a criminal history. In certain embodiments, the method may further comprise maintaining a plurality of prospective tenant profiles in at least one database.

According to another illustrative embodiment of the present disclosure, there is provided a method which includes creating a tenant profile in at least one database based on a request of a prospective tenant; receiving real estate preferences associated with a desired real estate property and associating the real estate preferences with the tenant profile; matching, based on the real estate preferences, the tenant profile to a plurality of property owner profiles; and calculating a match score for each of the plurality of property owner profiles. The method can further comprise determining that the match score of at least one of the plurality of the property owner profiles is above a predetermined value, and, based on the determination, enabling interaction between the prospective tenant and at least one property owner associated with a property owner profile having the match score above the predetermined value.

According to yet another illustrative embodiment of the present disclosure, there is provided a method which includes creating a property owner profile in at least one database based on a request of a property owner; receiving tenant preferences associated with a desired prospective tenant and linking the tenant preferences to the property owner profile; matching, based on the tenant preferences, the property owner profile to a plurality of tenant profiles; and calculating a match score for each of the plurality of tenant profiles. The method can further comprise determining that the match score of at least one of the plurality of tenant profiles is above a predetermined value, and based on the determination, enabling interaction between the property owner and at least one prospective tenant associated with a tenant profile having the match score above the predetermined value.

In further example embodiments, steps of method(s) described herein may be stored on a computer readable storage medium having a program embodied thereon, with the program executable by a processor in a computing device. In yet further exemplary embodiments, modules, systems, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements.

FIG. 1 shows an example high-level system environment (architecture) suitable for implementing the methods described herein.

FIG. 2 shows a high-level block diagram illustrating an example platform suitable for implementing the methods described herein.

FIG. 3 shows a high-level process flow diagram of a method for creating a tenant profile and matching the tenant profile to property owner profiles, according to one exemplary embodiment.

FIG. 4 shows an exemplary graphical user interface displaying a map with indications of real estate properties available for lease or purchase.

FIG. 5 shows a high-level process flow diagram of a method for creating a property owner profile and matching the property owner profile with tenant profiles according to one exemplary embodiment.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

This disclosure relates generally to a web service for searching and matching real estate offers to prospective tenants. More specifically, this disclosure relates to computer-implemented methods for matching prospective tenants to property owners based on predetermined preferences and rules. This disclosure further provides for automatic tenant screening as well as for aggregating information valuable to prospective tenants including demographics, rankings, criminal statistics, wealth statistics, and so forth.

As outlined above, embodiments of the present disclosure provide for computer-implemented methods for matching prospective tenant profiles to property owner profiles based on predetermined rules, predetermined property owner preferences, and prospective tenant preferences. In addition, the present technology allows for automatic screening of tenants before their tenant profiles are matched to property owner profiles. Moreover, the present technology allows for automatic aggregation of additional statistical information associated with a particular property owner, real estate listing, and/or neighborhood, and showing this information to the prospective tenant before he contacts the property owner.

Accordingly, the embodiments of the disclosure allow prospective tenants to obtain comprehensive information about property owners and the nearby area associated with the real estate of their interest without the need for conducting additional searches. Moreover, the property owners do not need to conduct additional searches or do screening of their prospective tenants because the screening results can be available to the property owners through the tenant profiles.

In another example embodiment of the present disclosure, the technology can be utilized not only by landlords to determine whether to lease or sell a property, but also by loan officers, bankers, or others to determine whether to provide a loan or open a credit line. In this example, data verification, as well as screening results, credit score, verification of income level, and other data can be provided to loan officers through the service described above or through a similar web service.

These and other embodiments of the present disclosure will be described below with reference to the figures of drawings, wherein like reference numerals are used to refer to like elements throughout. In the following description, for purposes of explanation, numerous specific details are set forth in order to provide a thorough understanding of one or more embodiments. It may be evident, however, that such embodiments may be practiced without these specific details. In other instances, well-known structures, systems and devices are shown in block diagram form in order to facilitate describing one or more embodiments.

In the present disclosure, the terms “tenant” and “prospective tenant” refer to a first user of a first computing device willing to lease or purchase real estate property or a piece of land associated with a property owner. The term “property owner,” in this disclosure, refers to a second user of a second computing device who is an owner or lessor of real estate property or a piece of land. In the disclosure, the terms “real estate” and “real estate property” refer to a commercial or non-commercial real estate property including, for example, at least the following: a room, apartment, house, townhouse, condominium, building, office, retail store, warehouse, garage, parking lot, storage, and so forth.

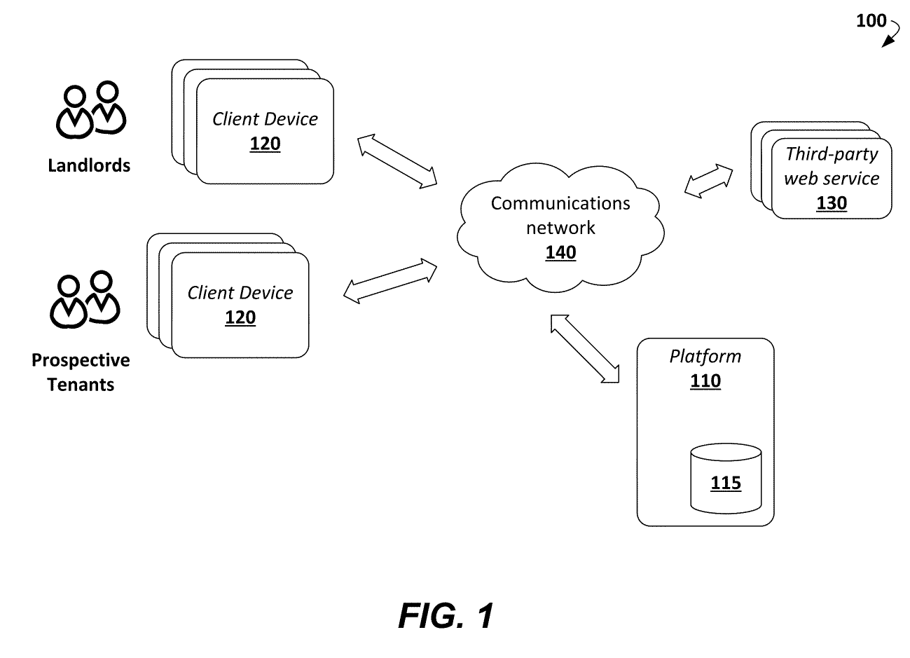

FIG. 1 shows a high-level system environment 100 suitable for implementing methods for matching tenant profiles with property owner profiles, according to an example embodiment of the present disclosure. The environment 100 includes a web platform 110, also referred herein to as a “platform,” which enables prospective tenants and property owners to find each other and communicate with each other in a simplified and enhanced manner as discussed below. The platform 110 may be implemented on a server and may run a website, which can be accessible to both prospective tenants and property owners via the Internet. In some embodiments, the platform 110 may provide an API (Application Programming Interface) so that the prospective tenants and property owners can access the platform 110 via a mobile application or a third-party network resource.

In general, the platform 110 enables prospective tenants to create and maintain tenant profiles, search real estate offers, obtain additional information about real estate properties and their property owners, match tenant profiles with property owner profiles, and so forth. The platform 110 also enables the property owners to create and maintain property owner profiles, search prospective tenants, obtain additional information about prospective tenants, do background screening, match property owner profiles with tenant profiles, and so forth. Thus, the platform 110 can include at least one database 115 for storing and maintaining a plurality of tenant profiles and a plurality of property owner profiles, as well as tenant preferences, real estate preferences, real estate property listings, rules, and so forth.

Still referring to FIG. 1, prospective tenants and property owners can access the platform 110 through client devices 120. The term “client device,” in this disclosure, refers to a wide range of portable or non-portable computing devices such as cellular telephones, smartphones, personal digital assistants (PDAs), tablet computers, laptop computers, desktop computers, thin clients, and so forth. Accordingly, to access the platform 110, tenants or property owners need to visit an associated website through a browser of their client devices 120 or a specific mobile application.

In yet another embodiment, prospective tenants or property owners may use the functionalities of the platform 110 indirectly through a third-party web service 130. In other words, third-party real estate listing websites can communicate with the platform 110 via an API such that the third-party real estate listing websites can provide the same or similar functionality as the platform 110 could provide through its own website or associated mobile applications.

The platform 110 may also communicate with third-party web services 130 to acquire specific information upon request of a prospective tenant or property owner. For example, the platform 110 may acquire from the third-party web services 130 statistical information about an area where a particular real estate property listed is located such as crime level information, demographics, income/wealth levels, school locations and school ranks, area reviews, point of interest locations and reviews, property owner reviews and rankings, and so forth. Accordingly, this or similar information can become available to prospective tenants via the platform 110.

In another example, the platform 110 may acquire from the third-party web services 130 particular information about prospective tenants and display it to property owners. This information may include tenant screening results, tenant credit score, tenant crime history, tenant income level, employment verification results, and any other personal information. Accordingly, this or similar information can become available to property owners to review through the platform 110.

As shown in FIG. 1, the communication between the platform 110, client devices 120, and third-party web services 130 can be implemented through one or more communications networks 140 which may include, but are not limited to, the Internet, intranet, local area network (LAN), wide area network (WAN), cellular phone networks (e.g. Global System for Mobile (GSM) communications network, packet switching communications network, circuit switching communications network), Bluetooth radio, and an IEEE 802.11-based radio frequency network (e.g., Wi-Fi®), among others.

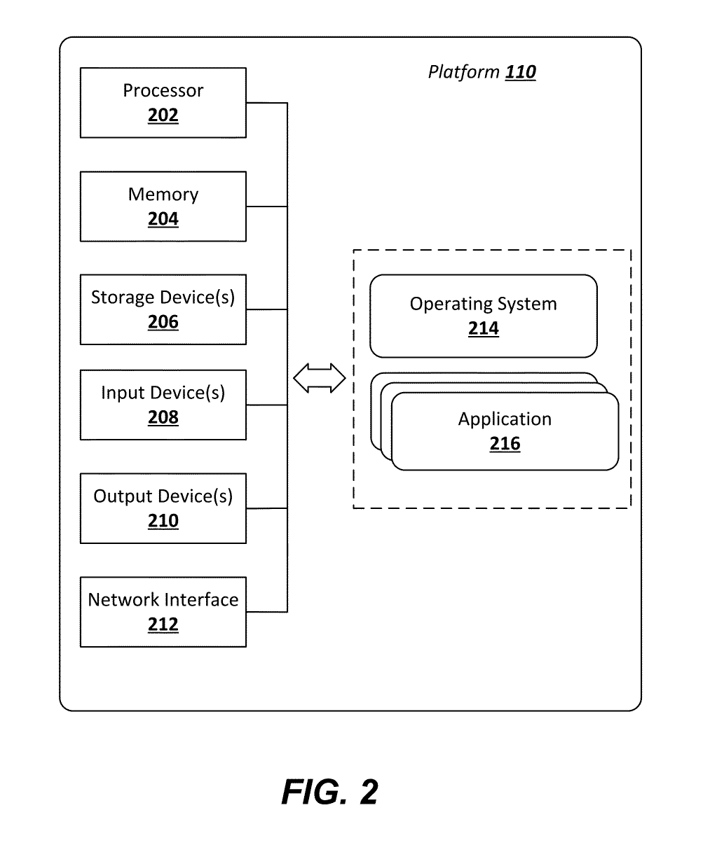

FIG. 2 is a high-level block diagram illustrating an example platform 110 suitable for implementing the methods described herein. In particular, the platform 110 may be used for running a website or dedicated web service enabling creation of their profiles by prospective tenants and property owners, and automatically matching these profiles based on predetermined rules, preferences and optional user selections.

In general, the platform 110 may include, be, or be an integral part of at least a variety of types of devices and systems such as a general-purpose computer, desktop computer, server, web server, Apache HTTP server, computer network, network service, cloud computing service, web service, web hosting service, and so forth. In some embodiments, the platform 110 has cloud-based implementation meaning it integrates multiple web servers and their services.

As shown in FIG. 2, the platform 110 includes one or more processors 202, a memory 204, one or more storage devices 206, one or more optional input devices 208, one or more optional output devices 210, and a network interface 212. One or more processors 202 are, in some examples, configured to implement functionality and/or process instructions for execution within the platform 110. For example, the processors 202 may process instructions stored in memory 204 and/or instructions stored on storage devices 206. Such instructions may include components of an operating system 214 or software application 216. Platform 110 may also include one or more additional components not shown in FIG. 2, such as a housing, power supply, communication bus, and so forth.

Memory 204, according to one example, is configured to store information within the platform 110 during operation. Memory 204, in some example embodiments, may refer to a non-transitory computer-readable storage medium or a computer-readable storage device. In some examples, memory 204 is a temporary memory, meaning that a primary purpose of memory 204 may not be long-term storage. Memory 204 may also refer to a volatile memory, meaning that memory 204 does not maintain stored contents when memory 204 is not receiving power. Examples of volatile memories include random access memories (RAM), dynamic random access memories (DRAM), static random access memories (SRAM), and other forms of volatile memories known in the art. In some examples, memory 204 is used to store program instructions for execution by the processors 202. Memory 204, in one example, is used by software (e.g., the operating system 214) or applications 216, such as a software, firmware, or middleware for matching tenant profiles with property owner profiles.

One or more storage devices 206 can also include one or more transitory or non-transitory computer-readable storage media and/or computer-readable storage devices. In some embodiments, storage devices 206 may be configured to store greater amounts of information than memory 204. Storage devices 206 may further be configured for long-term storage of information. In some examples, the storage devices 206 include non-volatile storage elements. Examples of such non-volatile storage elements include magnetic hard discs, optical discs, solid-state discs, flash memories, forms of electrically programmable memories (EPROMs) or electrically erasable and programmable memories (EEPROMs), and other forms of non-volatile memories known in the art. For example, storage devices 206 may store one or more databases 115 for maintaining tenant profiles and property owner profiles, as well as their preferences, personal information, and so forth.

Still referencing FIG. 2, the platform 110 optionally includes one or more input devices 208. The input devices 208 are configured to receive input from users such as prospective tenants or property owners. Examples of input devices 208 may include a keyboard, keypad, mouse, trackball, touchscreen, touchpad, microphone, camera, or any other device capable of detecting and/or receiving an input from a user or other source in any suitable format (e.g., including voice or speech input, gestures, touches, presses, and clicks) and relaying the input to platform 110, or components thereof. The optional output devices 210, in some examples, are configured to provide output to users through visual or auditory channels. Output devices 210 include a video graphics adapter card, liquid crystal display (LCD) monitor, light emitting diode (LED) monitor, sound card, a speaker, or any other device capable of generating output that may be intelligible to a user.

The platform 110 includes a network interface 212. The network interface 212 can be utilized to communicate with external devices and servers via one or more networks 140 such as one or more wired, wireless, or optical networks including, for example, the Internet, intranet, LAN, WAN, cellular phone networks, Bluetooth radio, an IEEE 802.11-based radio frequency network, and so forth. The network interface 212 may be a network interface card, such as an Ethernet card, an optical transceiver, a radio frequency transceiver, or any other type of device that can send and receive information. Other examples of such network interfaces 212 may include Bluetooth®, 3G, 4G, and WiFi® radios in mobile computing devices as well as USB.

The operating system 214 may control one or more functionalities of platform 110 and/or components thereof. For example, the operating system 214 may interact with the applications 216, and may facilitate one or more interactions between applications 216 and at least processors 202, memory 204, storage devices 206, input devices 208, and output devices 210. As shown in FIG. 2, the operating system 214 may interact with or be otherwise coupled to the applications 216 and components thereof. In some embodiments, the applications 216 may be included in the operating system 214.

Still referencing FIG. 2, the software implemented applications 216 may execute or facilitate execution of the methods disclosed herein. In particular, these applications 216 may provide API enabling interaction with the third-party web services 130, automatically aggregate information valuable to prospective tenants or property owners, implement background checks and screenings, acquire credit score reports, acquire criminal record reports, acquire income reports, acquire property owner reviews or ranks, acquire school reviews or ranks, create and maintain tenant and property owner profiles, and so forth. The applications 216 may cooperate with a website running on the platform 110 to provide the functionalities discussed herein or cooperate with mobile applications through API.

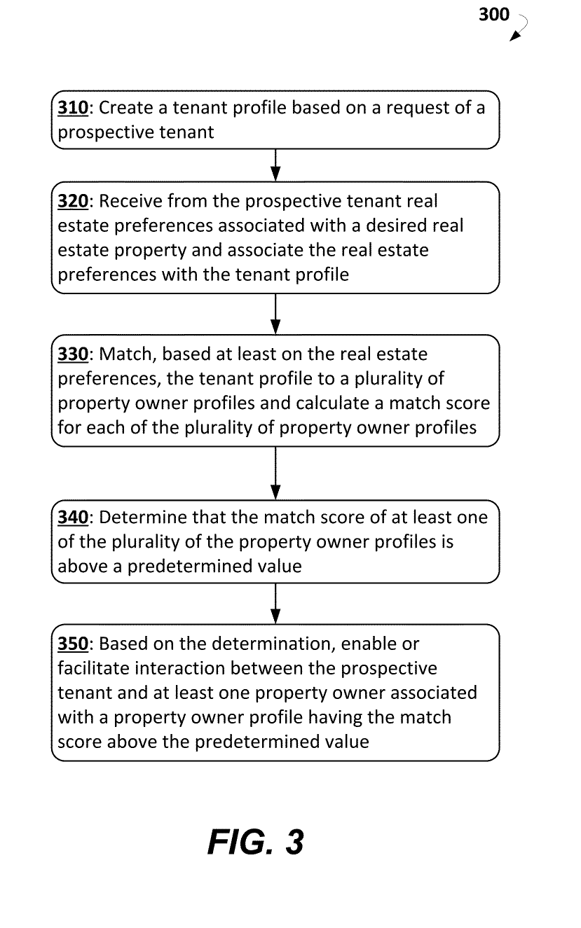

FIG. 3 shows a high-level process flow diagram of a method 300 for creating a prospective tenant profile and matching it to property owner profiles, according to one exemplary embodiment. The method 300 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 300 is implemented by the platform 110; however, it should be appreciated that the method 300 is just one example operation of the platform 110. In addition, the below recited steps of the method 300 may be implemented in an order different than described and shown in FIG. 3. Moreover, the method 300 may have additional steps not shown herein, but which can be evident for those skilled in the art from the present disclosure. The method 300 may also have fewer steps than outlined below and shown in FIG. 3.

The method 300 commences at step 310 with the platform 110 allowing a first user (i.e., a prospective tenant) to access the platform 110 and create a tenant profile. This step can be accomplished through a number of possible operations, which are discussed below.

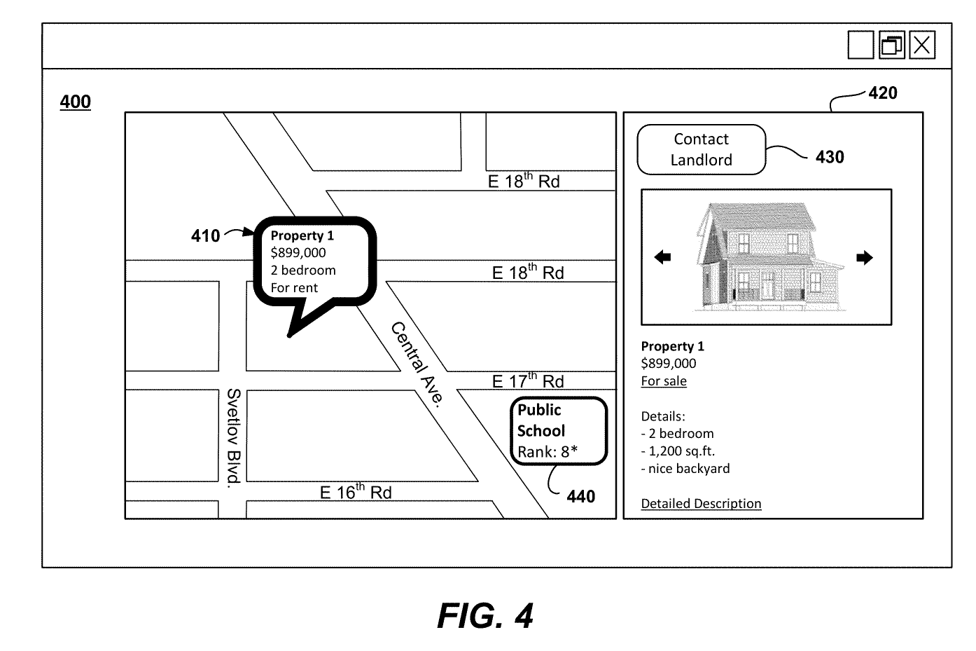

In a first example, the prospective tenant can use his client device 120 and access a dedicated website hosted, for example, by the platform 110 or any other web server. The website may provide a plurality of functionalities to the prospective tenant. For example, the prospective tenant can run a search of real estate properties according to specific parameters. For these ends, the prospective tenant can simply enter a location or a zip code of his interest, and the website, in response to this inquiry, will display a virtual map indicating one or more real estate properties that the prospective tenant can rent or purchase. An exemplary graphical user interface 400 displaying a map with indications 410 of real estate properties available for lease or purchase is shown in FIG. 4. As shown in this figure, the indication 410 may show some basic information about the real estate property such a thumbnail image, listed price, number of bedrooms, square footage, or any other valuable information. In other embodiments, the prospective tenant inquiry may be a more complicated one. For example, the prospective tenant may input multiple parameters selected from the group including, but not limited to, a price range, location, number of bedrooms, square footage or size range, number of floors, construction year, proximity to schools, proximity to public transport stops, proximity to any other public or non-public places, and so forth. In this example, the website may return more specific search results.

It is worth mentioning that the real estate listings may be stored in the platform 110 (e.g., the database 115). However, in alternative embodiments, the listings can be stored remotely to the platform 110 (e.g., at a third-party web service 130), and the platform 110 may access these listings automatically with the help of ad hoc API codes.

Referring now to FIG. 4, the prospective tenant may review search results on the virtual map. As shown in this figure, the graphical user interface 400 may also display additional information valuable to the prospective tenant for decision-making. In particular, the virtual map can indicate locations of at least the following: nearby schools, colleges, universities, day care centers, preschool child centers, hospitals, medical centers, parks, recreational areas, police stations, fire departments, stores, grocery stores, trade malls, offices, public transportation stops, parking lots, and so forth. In addition, the graphical user interface 400 may also optionally display ranks or reviews of specific public or non-public places (for example, the above listed). For example, the interface 400 may display a school rank, day care rank, college rank, and so forth. Moreover, the graphical user interface 400 may also optionally display statistical information such as demographics, crime levels, income levels, wealth levels, and population statistics (average age, gender, occupation, race, nationality, etc.). This statistical information can be stored in the platform 110 or aggregated from third-party web services 130 or other resources “on the fly” or upon request.

In case the prospective tenant wants to learn more about specific real estate property shown on the virtual map and indicated, for example, by the indication 410, the prospective tenant could simply click on the indication 410 such that a new widget 420 will be displayed partly overlaying the virtual map. The widget 420 may display more detailed information about the selected real estate property and its property owner. This may include, but is not limited to, an address, price, status (e.g., foreclosed, for sale, for rent, or any combination thereof), size or square footage, brief or detailed description, images or photos, videos, number of bedrooms, construction year, the existence of specific electrical devices (e.g., an air conditioning system, refrigerator, washing machine, drying machine), prior tenant reviews, a ranking, and so forth. The widget 420 may also include information about the property owner of the selected real estate property. This may include, but is not limited to, a name, photo, contact information, agent's name, website address, reviews, ranks, likes, hyperlinks, and so forth.

Therefore, the prospective tenant can easily not only search real estate listings, but also obtain important local information associated with the area of current search. Reviewing only a school ranking and crime level of a particular may not be sufficient in making a purchase or lease decision. It can be especially relevant in those situations when the prospective tenant has no particular knowledge of the area of his research, (e.g., when the prospective tenant needs to relocate to a new city or new neighborhood). Here, the interface 400 can show simultaneously, with the real estate listings, the location of the closest schools and their rankings, the overall crime level in this area, the average household income level in this area, and so forth. For example, the indication 440 in FIG. 4 shows a nearby school, which has the rank of eight stars.

In some embodiments of the present disclosure, the prospective tenant can apply specific filters to enable or disable overlaying of the virtual map with the additional local information. Any other online search tools can be also available to the prospective tenant to make the researching process as easy as possible.

If the prospective tenant is interested in contacting a specific property owner or his agent to negotiate the purchase or lease of a particular real estate listing, the prospective tenant may click a “Contact” button 430 as shown in FIG. 4. At this point of time, the website will determine if the prospective tenant is currently registered or logged on with the website. If yes, the website will provide the prospective tenant with desired contact information or online communication features. If not, the website can suggest that the prospective tenant register or log in before the prospective tenant can proceed further to use the functionalities of the website.

Now, referring back to FIG. 3, in a second example of the step 310, the prospective tenant can access the platform 110 through a mobile application installed on his client device 120 that can refer, for example, to a tablet computer or smart phone. The mobile application can provide the same functionality as described above in the first example. In particular, the mobile application can allow the prospective tenant to run a search among real estate listings, and it may display a virtual map, indications, and local information as shown, for example, in FIG. 4.

In yet another example of the step 310, the prospective tenant can access the platform 110 indirectly through a third-party web service 130. For example, there can be a third-party website hosted by a third-party server or a third-party mobile application, which can be in operative communication with the platform 110 and its functionality via an API or any suitable predetermined communication protocol. In this example, the platform 110 can provide web services to the third-party website only, and the third-party website provides an interface to enable the prospective tenant to utilize the functionalities of platform 110 without directly communicating with platform 110.

Eventually, upon invitation of the web site or a mobile application, the prospective tenant can create a tenant profile. The tenant profile can be stored, for example, in the database 115. Technically, the tenant profile may be similar to a profile in any social media that are widely known in the art. In an example, the tenant profile may include, but is not limited to, a photo, name, address, contact information (phone number, email address, website address), company name (optionally), age, gender, occupation, nationality, family size, number of children, income level, and so forth. The prospective tenant can also include additional private information, such as a social security number and a credit card number. The prospective tenant can also authorize the platform 110 or corresponding website to do a screening, background check, and verification of input data. In this regard, the platform 110 itself or through any suitable third-party web service 130 can verify a prospective tenant's name, address, phone number, and email address; obtain a credit report; obtain crime records; verify his employment; verify his income level; and so forth. Once at least this information is acquired, the tenant profile will be updated with acquired information by the platform 110 in real time. The tenant profile can also be editable meaning that the prospective tenant can later modify profile information or add new information. Of course, any modified or newly added information can be verified by the platform 110. Notably, the tenant profile containing verified information can be utilized later not only by landlords, but also by loan officers or companies for the purpose for making a loan decision and/or opening a new credit line.

Still referring to FIG. 3, once the tenant profile is created, at step 320, the platform 110 may invite the prospective tenant to run a search and input one or more real estate preferences. In certain embodiments, the real estate preferences can be stored to the tenant profile. The real estate preferences can include, but are not limited to, desired parameters of a real estate property or parcel of land that the prospective tenant desires to rent or purchase. For example, the real estate preferences include a location (e.g. a city or zip code), address, size range, price range, real property status (e.g., for sale, for rent, foreclosure), number of bedrooms, number of bathrooms, existence of particular electric devices (e.g., a washing machine, drying machine), proximity to particular public or non-public places (e.g., schools in general or schools with a particular rank or rank range), and so forth. As mentioned above, these or any other real estate preferences are associated with the tenant profile.

At step 330, the platform 110 automatically matches the tenant profile with a plurality of property owner profiles stored in the platform 110, database 115, or any third-party web service 130. The matching process may include comparing the real estate preferences of the prospective tenant with details or real estate listings as created by property owners or their agents. The matching process may also include comparing the tenant private information (e.g., credit score) with tenant preferences as stored in the property owner profiles (discussed below in detail). Importantly, for each “tenant/property owner” pair, the platform 110 may calculate a match score based on the real estate preferences, prospective tenant private (personal) information, tenant preferences, and property owner private information, as well as one or more predetermined rules. The predetermined rules can be stipulated by the platform's 110 personnel, prospective tenant, property owner, or any combination thereof.

At step 340, the platform 110 determines those property owner profiles, which possess a match score being above a predetermined value. The predetermined value can be fixed or it can be dynamically updated based on the real estate preferences, prospective tenant private (personal) information, tenant preferences, property owner private information, and one or more predetermined rules. Accordingly, the step 340 generates “match results” that include one or more tenant/property owner pairs with the highest match scores.

At step 350, the platform 110 enables the interaction between the prospective tenant and one or more property owners associated with the “match results.” In other words, the prospective tenant is enabled to communicate with those property owners whose property owner profiles are associated with the highest (above the predetermined value) match scores.

In various embodiments, the term “enabling” in the step 350 can mean disparate functionality of the platform 110. In one example, at the step 350, the website can display the “match results.” In other words, the website can display the property owner profiles having the highest match scores to the prospective tenant, for example, through the graphical interface 400 or any other interface. In another embodiment, the platform 110 or associated website may enable the prospective tenant to send an electronic message to the above mentioned property owners, or vice versa. In yet another embodiment, the platform 110 can output the match score and optionally the “match results” to a third-party web service 130 for further processing. In the latter example, the third-party web service 130 can enable communication between the prospective tenant and select property owners or at least allow them to see each other's contact details.

At further steps of method 300, the prospective tenant can continue using the functionalities of the platform 110 by generating new search requests, contacting other property owners, leaving reviews, ranking property owners or their real estate properties, and so forth.

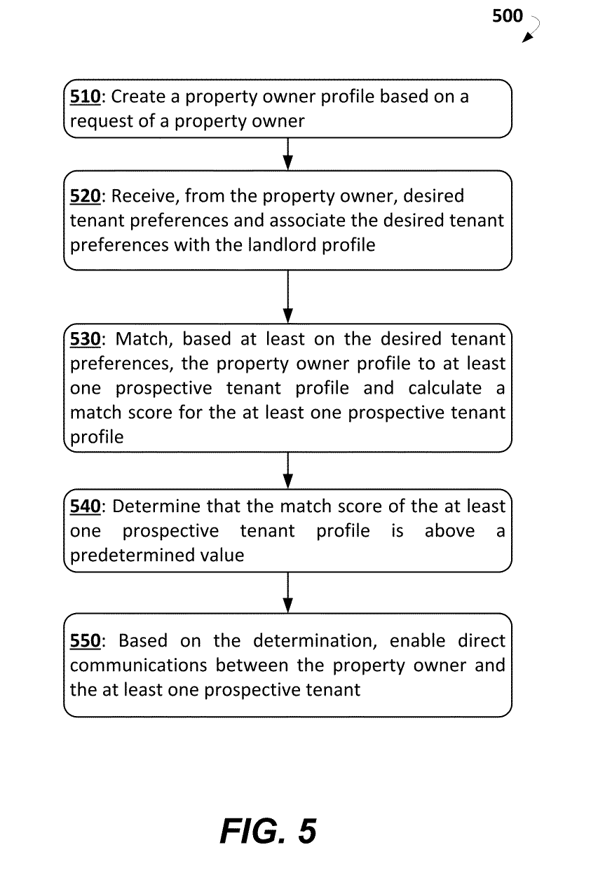

FIG. 5 shows a high-level process flow diagram of a method 500 for creating a property owner profile and matching profiles, according to one exemplary embodiment. The method 500 may be performed by processing logic that may comprise hardware (e.g., one or more processors, controllers, dedicated logic, programmable logic, and microcode), software (such as software run on a general-purpose computer system or a dedicated machine, firmware), or a combination of both. In some example embodiments, the method 500 is implemented by the platform 110; however, it should be appreciated that the method 500 is just one example operation of the platform 110. In addition, the below recited steps of the method 500 may be implemented in an order different than described and shown in FIG. 5. Moreover, the method 500 may have additional steps not shown herein, but which can be evident for those skilled in the art from the present disclosure. The method 500 may also have fewer steps than outlined below and shown in FIG. 5.

The method 500 commences at step 510 with the platform 110 allowing a second user (i.e., a property owner) to access the platform 110 and create a property owner profile. Similar to above, this step can be accomplished through a number of possible ways. In a first example, the property owner can use his client device 120 and access a dedicated website hosted, for example, by the platform 110 or any other web server. In a second example, the property owner can use his client device 120 having a dedicated mobile application, software application or middleware application allowing the property owner to utilize the functionalities of the platform 110. In a third example, the property owner can access a third-party website hosted by a third-party web server such as web service 130. In any case, the property owner can generate a real estate property listing or multiple listings and a property owner profile associated thereto. In addition, the property owner can be enabled to search and review prospective tenant profiles. Similar to above, the property owner can be allowed to communicate with a prospective tenant of his interest after the property owner created his property owner profile.

In either case, the property owner can create a property owner profile, which can be similar to a social media user profile. In particular, the property owner profile can include, but is not limited to, a photo, name, address, contact information (phone number, email, website), company name (optionally), age, gender, occupation, nationality, and so forth. The property owner can also include additional private (e.g., not viewable to anybody else) information, such as a social security number and a credit card number, which can be verified by the platform 110 for security purposes. Similar to the method 300 discussed above, the property owner can authorize the platform 110 or corresponding website to conduct a screening, background check, and verification of input data. In this regard, the platform 110 itself or through any suitable third-party web services 130 can verify a property owner's name, address, phone number, and email address; obtain a credit report; obtain crime records; verify his employment; and so forth. Once this information is acquired, the property owner profile can be updated with the acquired information by the platform 110. The property owner profile can also be editable anytime so that the property owner can modify information or add new information after the property owner profile is already created and even verified.

Further, the property owner can create one or more listings of real estate property or parcels of land that the property owner is willing to sell or lease. The listings, if created, can be associated with the respective property owner profile. In certain embodiments, an exemplary real restate listing may include, but not be limited to, an address, price, status (e.g., foreclosed, for sale, for rent, or any combination thereof), size or square footage, brief or detailed description, images or photos, videos, number of bedrooms, number of bathrooms, construction year, the existence of specific electrical devices (e.g., an air conditioning system, refrigerator, washing machine, drying machine), prior tenant reviews, a ranking, hyperlinks, and so forth.

Therefore, once one or more listings are created and stored to the database 115 or any other suitable storage device, prospective tenants can run searches among existing real estate listings. The tenants who actually purchased or rented a particular real estate property can create a review, make a comment, or rank real estate property such that this information becomes viewable to prospective tenants.

Still referring to FIG. 5, once the property owner profile is created, at step 520, the platform 110 may invite the property owner to input one or more tenant preferences. In certain embodiments, the tenant preferences can be stored to or associated with the property owner profile. In particular, the tenant preferences can include, but are not limited to, desired parameters of a prospective tenant that the property owner desires to deal with. For example, the tenant preferences can include, but not be limited to, an income range, credit score range, criminal history, employment verification, nationality, race, age range, gender, occupation, family status, number of prospective tenants (e.g., a family size or number of children), and so forth. As mentioned above, these or any other tenant preferences are associated with the property owner profile.

At step 530, the platform 110 automatically matches the property owner profile with a plurality of tenant profiles stored in the platform 110, database 115, or any third-party web service 130. The matching process may include comparing the tenant preferences of the property owner with prospective tenant profiles or their details. The matching process may also include comparing the tenant private information (e.g., credit score, criminal history/records, income level) with tenant preferences as created by the property owner and stored in the property owner profile.

Similar to that discussed above, for each tenant/property owner pair, the platform 110 may calculate a match score based on the tenant preferences, prospective tenant private (personal) information, real estate preferences, and property owner private information, as well as one or more predetermined rules. The predetermined rules can be stipulated by the platform's personnel, prospective tenant, property owner, or any combination thereof.

At step 540, the platform 110 determines those tenant profiles that possess a match score being above a predetermined value. The predetermined value can be fixed or it can be dynamically updated based on the real estate preferences, prospective tenant private (personal) information, tenant preferences, property owner private information, and one or more predetermined rules. Accordingly, the step 540 generates match results that include one or more tenant/property owner pairs with the highest match scores.

At step 550, the platform 110 enables the interaction between the property owner and one or more prospective tenants associated with the match results. In other words, the property owner is enabled to communicate with those prospective tenants whose tenant profiles are associated with the highest match scores.

In various embodiments, the step 550 can provide various functionalities of the platform 110. In one example, at the step 550, the website can display the match results and, therefore, provide the property owner with the contact details of the prospective tenants or allow the property owner to review select tenant profiles. In certain embodiments, the website can display the prospective tenant profiles having the highest match scores to the property owner, for example, through the graphical interface 400 or any other suitable interface. In another embodiment, the platform 110 or associated website may enable the property owner to send an electronic message to the above-mentioned prospective tenants, or vice versa. In yet another embodiment, the platform 110 can output the match score and optionally the match results to a third-party web service 130 for further processing such that the third-party web service 130 can enable the property owner and select prospective tenants to communicate with each other or at least see each other's contact details. At further steps of method 500, the property owner can continue using the functionalities of the platform 110 by generating new search requests, contacting various prospective tenants, leaving reviews, and so forth.

Thus, systems and methods for searching real estate offers and creating and matching tenant and property owner profiles have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method, comprising:
creating, by a processor, a tenant profile in at least one database based on a request of a prospective tenant;
receiving, by the processor from the prospective tenant, real estate preferences associated with a desired real estate property and associating the real estate preferences with the tenant profile;
creating, by the processor, a property owner profile in the at least one database based on a request of a property owner;
receiving, by the processor from the property owner, tenant preferences associated with a desired prospective tenant and associating the tenant preferences with the property owner profile;
matching, by the processor, based on the real estate preferences and the tenant preferences, the property owner profile to the tenant profile and calculating a match score;
determining, by the processor, that the match score is above a predetermined value; and
based on the determination, enabling, by the processor, interaction between the property owner and the prospective tenant.

2. The method of claim 1, wherein the enabling of interaction comprises displaying the property owner profile to the prospective tenant or displaying the tenant profile to the property owner.

3. The method of claim 1, wherein the enabling of interaction comprises providing a user interface enabling the prospective tenant to send electronic messages to the property owner, or enabling the property owner to send electronic messages to the prospective tenant.

4. The method of claim 1, wherein the enabling of interaction comprises outputting the match score and at least some information related to the property owner profile and the tenant profile to a third-party server for further processing.

5. The method of claim 1, further comprising:
conducting, by the processor or a third-party server, a criminal record check of the prospective tenant based at least in part on the tenant profile; and
updating, by the processor, the tenant profile with a result of the criminal record check.

6. The method of claim 1, further comprising:
conducting, by the processor or a third-party server, a credit score check of the prospective tenant based at least in part on the tenant profile; and
updating, by the web server, the tenant profile with a result of the credit score check.

7. The method of claim 1, further comprising:
conducting, by the processor or a third-party server, income verification of the prospective tenant based at least in part on the tenant profile; and
updating, by the web server, the tenant profile with a result of the income verification.

8. The method of claim 1, further comprising:
conducting, by the processor or a third-party server, employment verification of the prospective tenant based at least in part on the tenant profile; and
updating, by the web server, the tenant profile with a result of the employment verification.

9. The method of claim 1, further comprising providing, by the web server, at least one user interface accessible by the prospective tenant and/or the property owner, wherein the at least one user interface enables the prospective tenant to create and modify the tenant profile, the property owner to create and modify the property owner profile, enables the prospective tenant and the property owner to communicate with each other, and enables the prospective tenant and the property owner to search third-party property owner profiles and/or third-party tenant profiles.

10. The method of claim 9, wherein the at least one user interface further comprises a map, and the at least one user interface is further enabled to indicate on the map a location of at least one real property of the property owner based at least in part on the property owner profile.

11. The method of claim 10, wherein the at least one user interface is further enabled to indicate on the map locations of one or more the following: a day care center, a preschool child center, a school, a college, and a university.

12. The method of claim 10, wherein the at least one user interface is further enabled to display on the map locations of one or more the following: a park, a recreational center, a public transport stop, a grocery store, a trade mall, an office, a hospital, a medical center, a police department, and a fire department.

13. The method of claim 10, wherein the at least one user interface is further enabled to display on the map a rank associated with one or more the following: a day care center, a preschool child center, a school, a college, and a university.

14. The method of claim 10, wherein the at least one user interface is further enabled to display on the map a rank associated with one or more the following: an income level, a crime level, and a wealth index.

15. The method of claim 1, further comprising aggregating, by the web server, ranking and statistical information associated with a plurality of locations, wherein the ranking and statistical information for each location comprise at least the following: a school rank, day care rank, a college rank, crime related statistics, income statistics, and population related statistics.

16. The method of claim 1, wherein the real estate preferences associated with the desired real estate property comprise a location and at least the following: a type of the real estate property, a number of bedrooms, a square footage, a price, and a proximity to predetermined locations.

17. The method of claim 1, wherein tenant preferences associated with a desired prospective tenant comprise at least the following: a gender, an age, a number of prospective tenants, a price, an income level, a credit score, and a criminal history.

18. The method of claim 1, further comprising:
maintaining, by the processor, a plurality of prospective tenant profiles in the at least one database; and
maintaining, by the processor, a plurality of property owner profiles in the at least one database.

19. A method, comprising:
creating, by a processor, a tenant profile in at least one database based on a request of a prospective tenant;
receiving, by the processor from the prospective tenant, real estate preferences associated with a desired real estate property and associating the real estate preferences with the tenant profile;
matching, by the processor, based on the real estate preferences, the tenant profile to a plurality of property owner profiles and calculating a match score for each of the plurality of property owner profiles;
determining, by the processor, that the match score of at least one of the plurality of the property owner profiles is above a predetermined value; and
based on the determination, enabling, by the processor, interaction between the prospective tenant and at least one property owner associated with a property owner profile having the match score above the predetermined value.

20. A method, comprising:
creating, by a processor, a property owner profile in at least one database based on a request of a property owner;
receiving, by the processor from the property owner, tenant preferences associated with a desired prospective tenant and associating the tenant preferences to the property owner profile;
matching, by the processor, based on the tenant preferences, the property owner profile to a plurality of tenant profiles and calculating a match score for each of the plurality of tenant profiles;
determining, by the processor, that the match score of at least one of the plurality of the tenant profiles is above a predetermined value; and
based on the determination, enabling, by the processor, interaction between the property owner and at least one prospective tenant associated with a tenant profile having the match score above the predetermined value.
